(19) United States
(12) Patent Application Publication
(10) Pub. No.: US 2017/0244312 A1
(43) Pub. Date: Aug. 24, 2017

(54) TOPSIDES VARIABLE SPEED DRIVE FOR LARGE PUMPS OR COMPRESSORS

(71) Applicant: Aker Solutions AS, Lysaker (NO)

(72) Inventors: Truls NORMANN, Oslo (NO); Kjell Olav STINESSEN, Oslo (NO)

(73) Assignee: Aker Solutions AS, Lysaker (NO)

(21) Appl. No.: 15/504,592

(22) PCT Filed: May 18, 2015
(86) PCT No.: PCT/NO2015/050083

§ 371 Date: Feb. 16, 2017

(30) Foreign Application Priority Data
Aug. 18, 2014 (NO) 20140996

(51) Int. Cl. H02K 47/20; E21B 43/12; H02K 5/136; F16H 41/04; H02K 7/00; H02P 9/06

(52) U.S. Cl. CPC H02K 47/20; H02K 7/003; H02P 9/06; H02K 5/136; F16H 41/04; E21B 43/121

(57) ABSTRACT

The invention provides a topsides drive for electric centrifugal pumps or compressors, distinctive in that the drive comprises an electric motor, an electric generator, a variable stepless coupling connecting the motor to the generator, at least one housing, and penetrators through a wall of the at least one housing.

### FIELD OF THE INVENTION

The present invention relates to pressure boosting of liquids like oil, condensate and water, multiphase fluid or gases, by using a topsides drive for subsea or topsides pumps or compressors. More specifically, the invention relates to variable speed drives for subsea pumps and compressors and large pumps or compressors at topsides locations.

### BACKGROUND OF THE INVENTION AND PRIOR ART

A variable speed drive can vary the speed stepless of connected pumps or compressors in a range of speeds, as opposed to in pre-set steps, which is achieved with an adjustable speed drive, A variable speed drive, a VSD, has advantages for many reasons, typically related to better adaptation to process conditions, energy conservation, simplicity of operation, smoothness of operation and resulting advantages to mechanical equipment, and more. A typical variable speed drive for a pump or compressor is an electrical control unit with so-called power electrical components. Other drivers than VSDs based on power electronics are considered more expensive and less reliable than older versions with mechanical components, which are large, heavy and expensive, and often difficult or impossible to adapt to variable speed drive, The state of the art is therefore VSDs based on power electronics.

As explained in patent publication WO 2013/039404 A1, a marinised motor-generator set, a RotoConverter, can be favorable over VSDs based on power electronics for uses subsea. This is particularly the situation for long subsea step out lengths, for which the charging current of the subsea umbilical and transient currents of the subsea VSD interact with the surrounding water, or the Ferranti effect or other effects make the power transmission and speed drive unstable. The longer the subsea step out length, and the higher the transmission frequency of the subsea umbilical, the less stability must be expected. The RotoConverter of WO 2013/039404 A1 is a surprising solution to the problem of subsea pumping and compressing for the petroleum industry, eliminating negative effects of the subsea environment on the equipment. Said solution is surprising in view of the publication “Technical status and development needs for subsea gas compression”, OTC 18952, Offshore Technology Conference, Houston, Tex., USA 30 April-3 May 2007, which merely describes solutions with power electronics based VSDs as drives.

No teaching has been found on that variable speed drives having similarities to the subsea RotoConverter of WO 20131039404 A1 can be beneficial for use also on dry locations, such as topsides on platforms or similar structures. Currently, for use topsides, power electronics based VSDs are the only VSDs used in practice. Power electronics technology has reduced size and cost and improved performance of variable speed drives by using semiconductor switching devices and related technology, achieving total domination for drives for electric motors. For some applications, a step up transformer can be placed between the drive and the motor load. Medium voltage power electronics VSDs can be rated for 100 MW power rating, making power electronics based VSDs the obvious choice for the skilled person also for large pumps and compressors,

The objective of the invention is to provide alternative or advantageous drive technology for specific use.

### SUMMARY OF THE INVENTION

The invention provides a topsides drive for electric centrifugal pumps or compressors, distinctive in that the drive comprises
an electric motor,
an electric generator,
a variable stepless coupling connecting the motor to the generator,
at least one housing, and
penetrators through a wall of the at least one housing.

Preferably, the topsides drive, in the following also termed drive, comprises a hydraulic variable stepless coupling. The electric motor is preferably an AC motor, alternatively the electric motor is a DC motor. The generator is preferably an AC generator, alternatively the generator is a DC generator,

Preferably, the topsides drive comprises at least one housing for explosion proof encapsulation of the motor, the generator and the hydraulic coupling from the surroundings, and explosion proof penetrators through the at least one housing wall.

The topsides drive of the invention is conveniently connected to drive one or more of: subsea electric centrifugal pumps, subsea electric centrifugal compressors, topsides electric centrifugal pumps and topsides electric centrifugal compressors. Said subsea pumps and compressors are preferably located within 40 km from the topsides drive, to ensure stable power transmission. The total drive effect of the topsides drive of the invention preferably is from 2 MW and higher, more preferably 3 MW and higher, most preferably 6 MW and higher.

Centrifugal pumps or compressors, for power levels from about 2-6 MW and higher, are termed large or high effect pumps and compressors. The drive of the invention provides a substantial and unexpected technical effect over state of the art solutions for topsides drives based on power electronics VSDs, for large pumps and compressors, which will be clear from the following description.

Preferably, the hydraulic coupling is a turbo coupling for which the transmitted power and speed is controlled by controlling the degree of filling with hydraulic fluid, such as an oil or oil mixture. Preferably, the turbo coupling comprises a scoop tube or a similar device for controlled filling or controlled variable position for controlling the amount of oil in the coupling, thereby controlling the effect and speed of the coupling. This embodiment is a friction type hydraulic coupling.

In an alternative embodiment, the hydraulic coupling comprises closed or shrouded impellers, a bypass line and a control valve for variable speed control. For applications with almost only steady state operation, this can be preferable, since the efficiency can be high since this embodiment is a displacement type hydraulic coupling.

The drive preferably comprises a cooling circuit with a cooler, arranged inside the housing or with a cooler outside the housing, or coolers both inside and outside of the housing.

Preferably, a common housing contains the motor, the generator and the variable stepless coupling. The housing or housings are preferably either filled with oil or inert gas or filled with both oil and inert gas, such as partly filled with oil. Other liquid can replace oil, such as water-glycol mixture. Air or other gas can replace inert gas.

The invention also provides use of a drive according to the invention, for variable speed drive of pumps and compressors on topsides, dry locations and subsea locations, said subsea locations are preferably within 40 km from the topsides drive to ensure stable energy supply. However, by using a high voltage generator in the drive and a high voltage subsea motor, larger distances than 40 km between drive and subsea pump will be feasible and high voltage trafo topsides and subsea will be eliminated. Alternatively, a high voltage trafo topsides and a high voltage trafo subsea will make distance between topsides drive and subsea pump larger than 40 km feasible. The use is preferably for driving pumps and compressors on or near unmanned platforms or platforms normally unmanned, for production of petroleum offshore or injection of water.

As mentioned, the technical effect of the topsides drive of the invention is substantial and surprising, for which reason the drive of the invention differs essentially from prior art solutions. More specifically, MTTF (mean time to failure) of a drive of the invention is estimated to be about 111 years. The MTTF for a state of the art power electronics based VSD is about 33 years, for the same driven effect. Accordingly, the reliability is three times better or more which is substantial and surprising. A state of the art VSD weights typically 5-20 metric tons topside, within 3-18 MW effect. Transformer of 5 to 30-40 metric tons must be added. In comparison, the drive of the invention weight less than ⅓ and cost about ⅓, whilst having 3 times or more MTTF, for comparable effect, and no transformer of 5 to 30-40 metric tons is required. The saved weight will also have substantial impact, since 1 kg saved weight topsides saves 3 kg or more in structural weight, as a rule of thumb.

Without wishing to be bound by theory, it assumed that the improved reliability has to do with the complexity of power electronics based VSDs for high effects, requiring a huge number of components, comprehensive cooling and control. Even though each power electronic component has a very high reliability, say 99,999% for one year of operation, the reliability of the interacting components must typically be multiplied. With sufficiently high number of components and failure mechanisms, typically counted in thousands, the resulting real life reliability of a typical power electronics based VSD will be reduced to ⅓ or less of the resulting reliability of the drive of the invention.

More specifically, the drive of the invention weight less than ⅓ and cost about ⅓, whilst having 3 times or more MTTF, for a total drive effect of 6 MW. The technical effect of the drive of the invention is improvement by a factor of 3 with respect to reliability and ⅓ with respect to weight and cost. It is therefore reason to believe that the point of effect when the drive of the invention no longer is advantageous over state of the art power electronics VSDs is at about 2 MW total drive effect. The drive of the invention therefore preferably has a total effect of 2 MW or higher, more preferably 3 MW or higher, most preferably 6 MW or higher.

Feasible hydraulic couplings for the drive of the invention, or existing couplings that can be modified, are available from Voith, NARA Corporation, GM, Mitsubishi, DKM and probably others. None of said suppliers have used or considered to use their hydraulic couplings for topsides stepless drives for pumps or compressors, at power levels over about 2-6 MW. Prior use has been in railway locomotives, nuclear power plants for control of moderation rod positions and coolant, or more remote fields of use. Alternatively, the drive of the invention comprises a magnetic coupling.

### FIGURES

The drive of the invention is illustrated with two figures, of which;

FIG. 1 illustrates a drive of the invention with a turbo coupling and a common housing, with internal cooling, and

FIG. 2 illustrates another embodiment of a drive of the invention, with a displacement type hydraulic coupling, two housings and an external cooler.

### DETAILED DESCRIPTION

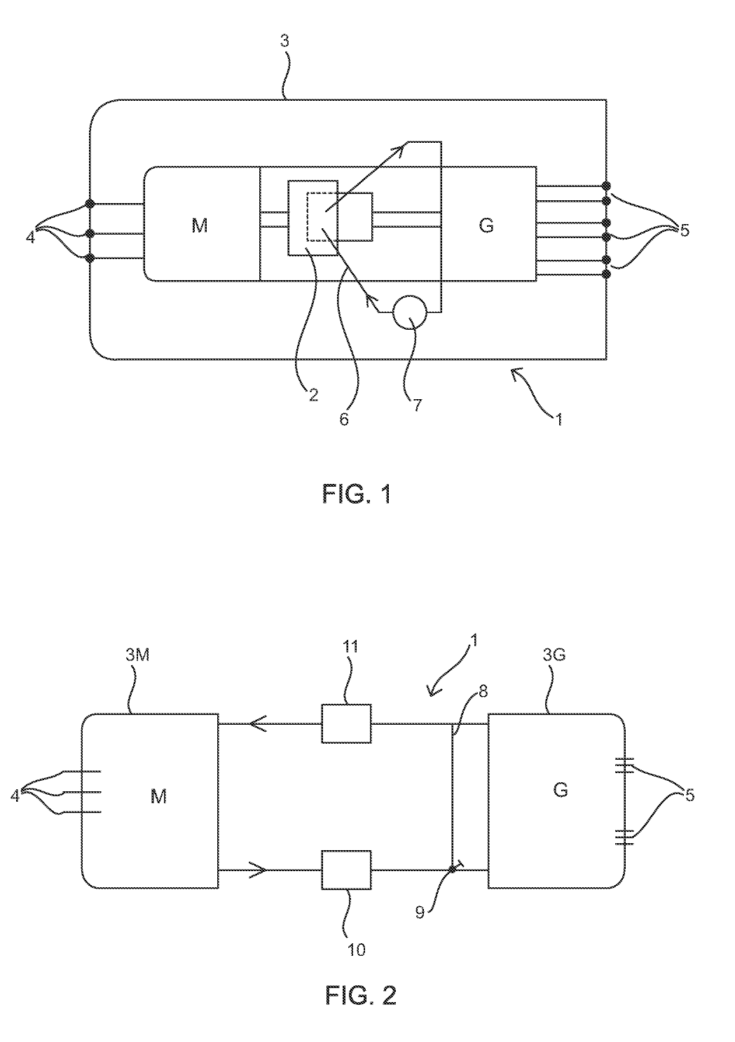

Reference is made to FIG. 1, illustrating a drive 1 of the invention with a turbo coupling 2 and a common housing 3, with internal cooling (not shown). The drive comprises an electric motor M and an electric generator G, coupled together via the turbo coupling 2, which is a variable stepless coupling. The housing 3 is explosion proof, so called Ex safe and may comprise equipment for pressure control and detection of explosive gas (not illustrated). The drive comprises electric penetrators 4 to the motor and electric penetrators 5 from the generator to connected pumps and compressors (not illustrated). The speed and effect of the connected generator is controlled by controlling the filling level of hydraulic oil of the turbo coupling, which is controlled with pump 7 and filler tube 6. The hydraulic coupler comprises a cooler (not illustrated) and a reservoir (not illustrated) for full control of level and temperature, for coupling the generator to the motor as a stepless coupling from 0% to approximately 100% coupling depending on the filling level of oil. At full filling, the friction between the driving impeller, connected to a motor shaft, and the driven impeller, connected to a generator shaft, is at maximum, providing maximum coupling, of approximately 100%, At steady state operation, which will be the expected operation mode almost all the time, the coupling and hence the efficiency is close to 100%, for example 98% or better. Less than 2% is lost as heat, which must be tolerated or be handled by a cooler. Also, additional equipment and additional cooling will be required, for achieving reliability for the motor and the generator. Bearings need lubrication and cooling, and separate or common coolant and coolers will typically be required, in addition to instrumentation for control and monitoring. However, the skilled person will know how to use good engineering practice to ensure a reliable motor and generator, and details on this are therefore neither illustrated nor described.

FIG. 2 illustrates another embodiment of a drive 1 of the invention, with a displacement type hydraulic coupling, two housings and an external cooler. More specifically, the drive comprises a separate motor housing 3M and a separate generator housing 3G. The hydraulic coupling comprises closed or shrouded impellers, with a driving impeller in the motor housing and a driven impeller in the generator housing. Closed or shrouded impellers means that the flowing fluid for the coupling flows through the impellers via more or less closed volumes between the impeller blades, meaning that the rotating impellers are operating in a displacement like way, since the volumes between impeller blades are in substance confined or closed. This means that the flow of oil couples the impellers, not the friction in oil between closely arranged impellers as for a turbo coupling. This also means that the variable stepless speed or coupling must be controlled in a different way, more specifically by a bypass line 8 and a control valve 9, as illustrated, or in similar ways. For all steady state operation of connected pumps and compressors, the bypass line will preferably be closed for flow, for best efficiency. However, for transient operation, the bypass line will be gradually opened or closed for flow by operating valve 9. In the illustrated embodiment, the lines between the motor impeller and the generator impeller contains a cooler 10 and an oil reservoir 11.

The topsides drive of the invention can include any feature or step as here described or illustrated, in any operative combination, each such operative combination is an embodiment of the present invention. The use of the invention can include any feature or step as here described or illustrated, in any operative combination, each such operative combination is an embodiment of the present invention. For example, the invention also comprises a pressure boosting system comprising a topsides drive of 2 MW or higher drive effect, such as 3 MW or 6 MW or higher effect, coupled to at least one of: topsides pumps and compressors and subsea pumps and compressors, the subsea pumps or compressors are preferably located nearer than 40 km from the drive but can be located further away as discussed above.

1. A topsides drive for electric centrifugal pumps or compressors, the topsides drive comprising:
an electric motor;
an electric generator;
a variable stepless coupling connecting the motor to the generator;
at least one housing; and
penetrators through a wall of the at least one housing.

2. The topsides drive according to claim 1, comprising a hydraulic variable stepless coupling.

3. The topsides drive according to claim 2, comprising:
at least one housing for explosion proof encapsulation of the motor, the generator and the hydraulic coupling from the surroundings;
explosion proof penetrators through the at least one housing wall; and
wherein the drive has effect from about 2 MW or higher, such as 3 MW or higher or 6 MW or higher.

4. The topsides drive according to claim 2, wherein:
the hydraulic coupling is a turbo coupling for which the transmitted power and speed is controlled by controlling the degree of filling with hydraulic fluid; and
the turbo coupling comprises a scoop tube with controlled variable position for controlling the amount of an oil as hydraulic fluid in the coupling, thereby controlling the effect and speed of the coupling.

5. The topsides drive according to claim 2, wherein the hydraulic coupling comprises closed or shrouded impellers, a bypass line and a control valve for variable speed control.

6. The topsides drive according claim 1, comprising a cooling circuit with a cooler, arranged with a cooler inside the housing or with a cooler outside the housing.

7. The topsides drive according to claim 1, wherein the housing or housings are filled with oil or inert gas or both oil and inert gas.

8. (canceled)

9. (canceled)
